(19) United States
(12) Patent Application Publication
(10) Pub. No.: US 2026/0291576 A1
(43) Pub. Date: Sep. 24, 2026

(54) METHOD AND APPARATUS FOR REPORTING CHANNEL INFORMATION IN MOBILE COMMUNICATIONS

(71) Applicant: MEDIATEK INC., Hsinchu City (TW)

(72) Inventors: Chia-Hao YU, Hsinchu City (TW); Tzu-Han CHOU, San Jose, CA (US); Chien-Hwa HWANG, Hsinchu City (TW); Jiann-Ching GUEY, Hsinchu City (TW); Pei-Kai LIAO, Hsinchu City (TW); Yih-Shen CHEN, Hsinchu City (TW); Chin-Kuo JAO, Hsinchu City (TW)

(21) Appl. No.: 19/473,426

(22) PCT Filed: Oct. 10, 2024
(86) PCT No.: PCT/CN2024/123925

§ 371 Date: Oct. 7, 2025

Related U.S. Application Data
(60) Provisional application No. 63/602,679, filed on Nov. 27, 2023.
(60) Provisional application No. 63/617,806, filed on Jan. 5, 2024.

(51) Int. Cl. H04B 7/06; H04L 5/00; H04L 27/26

(52) U.S. Cl. CPC H04B 7/0626; H04L 5/0044; H04L 27/261

(57) ABSTRACT

Various solutions for reporting channel information with respect to an apparatus in mobile communications are described. The apparatus may transmit a first channel information based on a first reference signal (RS). The first RS may be un-precoded. The apparatus may transmit a second channel information based on a second RS. The second RS may be precoded. The first channel information may include at least one parameter associated with the second RS.

### CROSS REFERENCE TO RELATED PATENT APPLICATION(S)

The present disclosure is part of a non-provisional application claiming the priority benefit of U.S. Patent Application No. 63/602,679, filed 27 Nov. 2023 and U.S. Patent Application No. 63/617,806, filed on 5 Jan. 2024, the contents of which herein being incorporated by reference in their entirety.

### TECHNICAL FIELD

The present disclosure is generally related to mobile communications and, more particularly, to reporting channel information with respect to apparatus in mobile communications.

### BACKGROUND

Unless otherwise indicated herein, approaches described in this section are not prior art to the claims listed below and are not admitted as prior art by inclusion in this section.

Channel State Information Reference Signal (CSI-RS) is a reference signal (RS) used in the downlink (DL) direction in 5G New Radio (NR). More specifically, CSI-RS is DL RS designed for channel sounding and measuring the characteristics of a radio channel, allowing for the use of proper modulation, coding rates, precoding, beamforming, etc. The user equipment (UE) may use the CSI-RS to measure the quality of the DL channel and report the result via the uplink (UL) transmission. From another perspective, the network node may transmit CSI-RS for obtaining channel status information such as Reference Signal Receiving Power (RSRP), Reference Signal Receiving Quality (RSRQ) and Signal to Interference plus Noise Ratio (SINR) for mobility procedures. Specific instances of CSI-RS may be configured for time/frequency tracking and mobility measurements.

CSI feedback is a scheme used by the UE to report certain channel parameters to the network node for e.g., dynamic scheduling purposes. CSI parameters are some quantities related to the state of a channel. The UE reports CSI parameters to the network node (e.g., gNB) as CSI feedback while these CSI parameters may include Channel Quality Indicator (CQI), Precoding Matrix Indicator (PMI) with different codebook sets, and Rank Indicator (RI). The CSI feedback may also include parameters indicating a CSI-RS resource (or CSI-RS resource set), based on which the CQI, PMI, and RI are derived and reported. The UE uses the CSI-RSs to measure and determine the CSI feedback. Upon receiving the CSI feedback, the network node may accordingly determine information (e.g., modulation scheme, code rate, number of transmission layers, and MIMO precoding) to schedule the DL data transmissions.

Sounding Reference Signal (SRS) is a reference signal used in the uplink (UL) direction in 5G New Radio (NR), to evaluate the quality and characteristics of the UL channel. In particular, the SRS is used for channel estimation and to assess the quality of the UL channel from the UE to the network node, which may help the network node allocate the network resources and optimize the communication between the UE and the network node. More specifically, the UE may transmit the SRS at regular intervals, and the network node (e.g., gNB) may use the SRS to measure the channel. In other words, the network node may derive some channel information according to the SRS.

In current NR CSI framework, the UE may report the CSI feedback to the network node for subsequent transmission between the UE and the network node. However, in some network scenarios, the network node may not adapt the CSI feedback reported by the UE but rather determine the precoder and/or RI based on the sounding reference signal (SRS), which is a reference signal transmitted from the UE to the network node for the network node to evaluate the quality and characteristics of the UL channel. In some network scenarios, mismatch between reported RI and actually transmitted spatial layer may make UE receiver adaptation difficult, which may impact UE power saving. In some network scenarios, mismatch between reported CQI and modulation coding scheme (MSC) may often occur. Therefore, performing a single procedure of CSI-RS and CSI feedback between the UE and the network node may not achieve a balance between efficiency and robustness in obtaining channel information.

Accordingly, how to achieve a balance between efficiency and robustness in obtaining channel information becomes an important issue in the newly developed wireless communication network. Therefore, there is a need to provide proper schemes to achieve a balance between efficiency and robustness in obtaining channel information.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to reporting channel information with respect to apparatus in mobile communications.

In one aspect, a method may involve an apparatus transmitting a first channel information bases on a first reference signal (RS). The first RS may be un-precoded. The method may also involve the apparatus transmitting a second channel information based on a second RS. The second RS may be precoded.

In one aspect, a method may involve an apparatus receiving a first channel information bases on a first RS. The first RS may be un-precoded. The method may also involve the apparatus receiving a second channel information based on a second RS. The second RS may be precoded.

In one aspect, an apparatus may comprise a transceiver which, during operation, wirelessly communicates with a wireless network. The apparatus may also comprise a processor communicatively coupled to the transceiver. The processor, during operation, may perform operations comprising transmitting, via the transceiver, a first channel information bases on a first RS. The first RS may be un-precoded. The processor may also perform operations comprising transmitting, via the transceiver, a second channel information based on a second RS. The second RS may be precoded.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reporting channel information with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, there may be at least a first channel information reporting loop and a second channel information reporting loop. In a first channel information reporting loop, a user equipment (UE) may transmit a first channel information to a network node based on a first reference signal (RS). The first RS may be an un-precoded signal. Based on the first channel information reporting loop, the network node may determine some channel parameters and schedule data transmission to the UE according to the first channel information which may be referred as a baseline channel information.

In a second channel information reporting loop, the UE may transmit a second channel information to the network node based on a second RS. The second RS may be a precoded signal. Based on the second channel information reporting loop, the network node may determine some channel parameters and schedule data transmission to the UE according to the second channel information which may be referred as a refined channel information.

In some network scenarios, comparing to the second channel information, the first channel information may include more information (e.g., more overhead) and less frequent transmissions while the first channel information is used for the network node to obtain the initial channel state. In other words, the second channel information may include less information (e.g., less overhead) and more frequent transmissions while the second channel information is used for the network node to update or refine the channel state. Accordingly, a balance between efficiency and robustness in obtaining channel information may be significant improved.

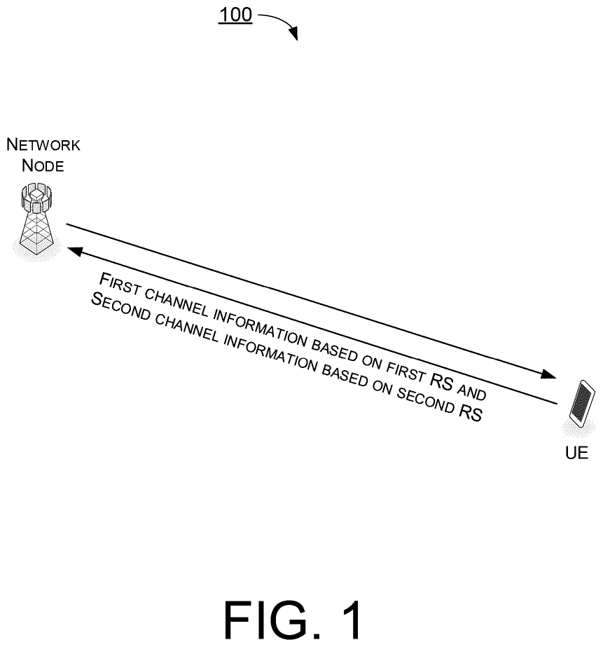

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

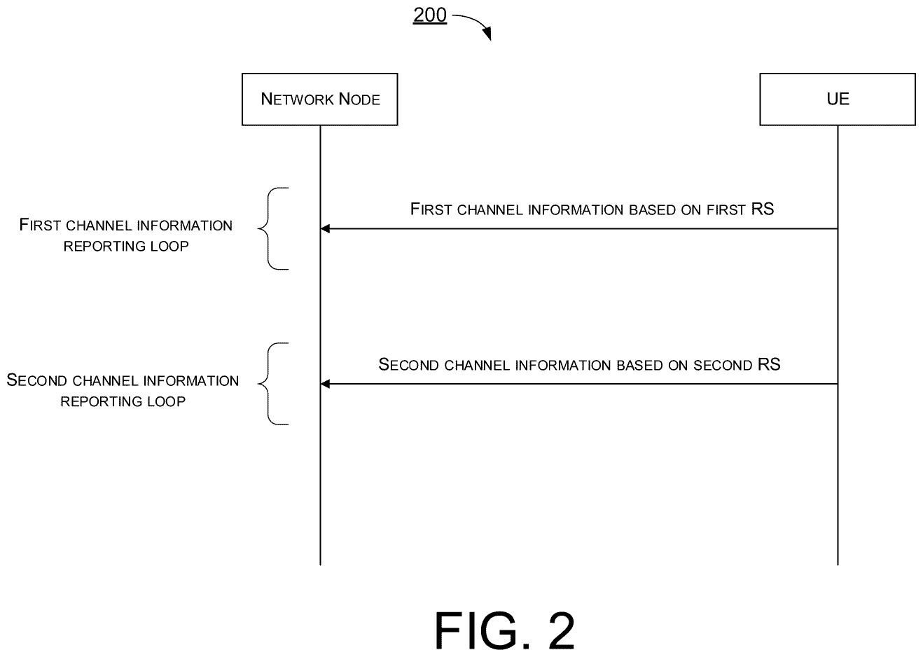

FIG. 2 illustrates an example scenario 200 under schemes in accordance with implementations of the present disclosure. In some embodiments, there may be at least two channel information reporting loops between the UE and the network node. In particular, in a first channel information reporting loop, the UE may transmit a first channel information to the network node based on a first RS. The first RS may be un-precoded. More specifically, the first RS may be an original signal that is directly transmitted without any additional processing or transformation (e.g., spatial processing, beamforming techniques, etc.) before transmission. Alternatively, the first RS may be processed but its processing detail is transparent to corresponding receiving node(s). Based on the first channel information reporting loop, the network node may determine some channel parameters (e.g., precoder parameters such as Precoding Matrix Indicator (PMI), rank parameters such as Rank Indicator (RI), channel quality parameters such as Channel Quality Indicator (CQI), Modulation and Coding Scheme (MCS) etc.) and schedule data transmission to the UE according to the first channel information which may be referred as a baseline channel information.

In some cases, the un-precoded first RS may be a channel state information RS (CSI-RS) transmitted from the network node to the UE. After receiving the CSI-RS from the network node, the UE may determine the first channel information according to the CSI-RS and transmit the first channel information to the network node. In these cases, the first channel information may be associated with at least one of precoder, rank and channel quality. After receiving the first channel information, the network node may determine at least one of precoder, rank and channel quality according to the first channel information.

For example, the first channel information includes at least one of PMI, RI and CQI which are determined by the UE. After receiving the first channel information, the network node determines at least one of PMI, RI and CQI directly. For another example, the first channel information includes at least one of: (1) reported multipaths; (2) spatial domain parameters (e.g., Angle-of-Departure (AoD) at the network node) of the reported multipaths; (3) a delay domain parameter of the reported multipaths; (4) a doppler domain parameter of the reported multipaths; (5) a path gain (e.g., complex gain or power gain) of reported multipaths; and (6) interference measurement information. After receiving the first channel information, the network node determines at least one of PMI, RI and CQI according to at least one of these parameters.

In some cases, the first RS may be a sounding reference signal (SRS) transmitted from the UE to the network node. The UE may transmit the SRS associated with the first channel information for the network node to determine (e.g., acquire) the first channel information. In these cases, the first channel information may be associated with at least one of precoder and rank. After acquiring the first channel information, the network node may determine at least one of precoder and rank according to the first channel information.

For example, the first channel information is associated with channel characteristic, such as delay, attenuations, phase shift, pathloss etc. After receiving the SRS associated with the first channel information and acquiring the first channel information, the network node determines at least one of PMI and RI according to the SRS with the first channel information.

In addition, when the first RS is the SRS transmitted from the UE, interference measurement information between the network node and the UE may not be determined from UE perspective. Therefore, the UE may receive a third RS from the network node and determine interference measurement information associated with channel quality. Then, the UE may transmit the interference measurement information to the network node. For example, the interference measurement information, the network node determines CQI directly. For another example, the interference measurement information includes an interference covariance matrix. After receiving the interference measurement information, the network node determines CQI according to the interference covariance matrix.

In some cases, under a multiple Transmit-Receive-Points (TRPs) scenario, the first channel information reporting loop may be utilized for selecting TRP(s) out of a candidate TRP set. In some cases, the first channel information reporting loop may be utilized for selecting a subset of antenna (ports) from an antenna (ports) set which may include antennas of different TRPs.

Further, in a second channel information reporting loop, the UE may transmit a second channel information to the network node based on a second RS. The second RS may be precoded. More specifically, the second RS may be a processed signal that has been processed using a precoding matrix or vector before transmission. In some cases, precoding may be a spatial signal processing technique used in multi-input multi-output (MIMO) system to optimize data transmission over multiple antennas. Based on the second channel information reporting loop, the network node may determine some channel parameters (e.g., precoder parameter PMI, rank parameter RI, channel quality parameter CQI, MCS, etc.) and schedule data transmission to the UE according to the second channel information which may be referred as a refined channel information.

In some cases, the precoded second RS may be a CSI-RS transmitted from the network node to the UE. After receiving the CSI-RS from the network node, the UE may determine the second channel information according to the CSI-RS and transmit the second channel information to the network node. In these cases, the second channel information may be associated with at least one of precoder, rank and channel quality. After receiving the second channel information, the network node may determine at least one of precoder, rank and channel quality according to the second channel information.

For example, the second channel information includes at least one of PMI, RI and CQI which are determined by the UE. After receiving the second channel information, the network node determines at least one of PMI, RI and CQI directly. For another example, the second channel information includes at least one of: (1) reported multipaths; (2) a spatial domain parameter (e.g., AoD at the network node) of the reported multipaths; (3) a delay domain parameter of the reported multipaths; (4) a doppler domain parameter of the reported multipaths; (5) a path gain (e.g., complex gain or power gain) of reported multipaths; and (6) interference measurement information. After receiving the second channel information, the network node determines at least one of PMI, RI and CQI according to at least one of these parameters.

In some cases, the precoded second RS may be a demodulation reference signal (DMRS) of a physical downlink shared channel (PDSCH) transmitted from the network node to the UE. After receiving the DRMS of the PDSCH from the network node, the UE may determine the second channel information according to the DMRS of the PDSCH and transmit the second channel information to the network node. In these cases, the second channel information may be associated with at least one of precoder, rank and channel quality. After receiving the second channel information, the network node may determine at least one of precoder, rank and channel quality

For example, the second channel information includes at least one of PMI, RI and CQI which are determined by the UE. After receiving the second channel information, the network node determines at least one of PMI, RI and CQI directly. For another example, the second channel information includes at least one of: (1) channel quality information related to deriving MCS for PDSCH transmission; (2) rank information for PDSCH rank adaptation (e.g., a bit map indicating good quality of a number of ports of the second RS); (3) precoder information for adjusting precoder at network node (e.g., an inter-port interference measurement, such as a covariance matrix, of a number of ports of the second RS); and (4) delay domain information for adjusting precoder per-subband.

In some cases, the second RS may be an SRS transmitted from the UE to the network node. The UE may transmit the SRS associated with the second channel information for the network node to determine (e.g., acquire) the second channel information. In these cases, the second channel information may be associated with at least one of precoder and rank. After acquiring the second channel information, the network node may determine at least one of precoder and rank according to the second channel information.

For example, the second channel information is associated with channel characteristic, such as delay, attenuations, phase shift, pathloss etc. After receiving the SRS associated with the second channel information and acquiring the second channel information, the network node determines at least one of PMI and RI according to the SRS associated with the second channel information.

In addition, when the second RS is the SRS transmitted from the UE, interference measurement information between the network node and the UE may not be able to be determined from UE perspective. Therefore, the UE may receive a third RS from the network node and determine interference measurement information associated with channel quality. Then, the UE may transmit the interference measurement information to the network node. For example, the interference measurement information includes CQI determined by the UE. After receiving the interference measurement information, the network node determines CQI directly. For another example, the interference measurement information includes an interference covariance matrix. After receiving the interference measurement information, the network node determines CQI according to the interference covariance matrix.

In some cases, the second channel information reporting loop may be used for collecting channel information of the selected TRP(s) or antenna subset determined in the first channel information reporting loop.

In some implementations, different types of the RSs may be used in different loops. In other words, a type of the first RS (e.g., CSI-RS or SRS) associated with the first channel information reporting loop may be different from a type of the second RS (e.g., CSI-RS, DMRS or SRS) associated with the second channel information reporting loop. In some implementations, the type of the RSs may be the same in different loops. In other words, a type of the first RS associated with the first channel information reporting loop may be the same as a type of the second RS associated with the second channel information reporting loop.

In some implementations, each of the first channel information reporting loop and the second channel information reporting loop may be periodically performed or aperiodically performed (e.g., trigger-based). In some cases, when both the first channel information reporting loop and the second channel information reporting loop are periodically performed, a periodicity of the first channel information reporting loop may be longer than a periodicity of the second channel information reporting loop. In some cases, the transmissions of the first channel information and the second channel information may be based on an aperiodic signaling (e.g., downlink control information (DCI) transmitted from the network node).

In some implementations, the first channel information may include at least one parameter associated with the second RS. For example, the UE indicates the at least one parameter in the first channel information to inform the network node on how to handle subsequent RS (e.g., how to receive subsequent SRS) in the second channel information reporting loop.

In some implementations, from a perspective of parameter tracking, parameters may be tracked by different schemes in different loops.

In some implementations, parameters associated with RI/PMI may be tracked by different schemes in the first channel information reporting loop and the second channel information reporting loop. In some cases, in the first channel information reporting loop, RI/PMI may be determined as baseline RI/PMI derivation at the network node according to the first channel information. In other words, in the first channel information reporting loop, the network node may determine baseline RI/PMI according to the first channel information.

For example, regarding RI/PMI tracking, the first channel information associated with the first RS (e.g., CSI-RS) includes PMI and RI which are determined by the UE. After receiving the first channel information, the network node determines PMI and RI.

For another example, regarding RI/PMI tracking, the first channel information associated with the first RS (e.g., CSI-RS) includes at least one of: (1) reported multipaths; (2) a spatial domain parameter (e.g., Angle-of-Departure (AoD) at the network node) of the reported multipaths; (3) a delay domain parameter of the reported multipaths; (4) a doppler domain parameter of the reported multipaths; and (5) a path gain (e.g., complex gain or power gain) of reported multipaths. After receiving the first channel information, the network node determines PMI and RI according to at least one of these parameters. It should be noted that which parameter(s) is (are) used may be configured by a configuration (e.g., higher layer configuration) from the network node.

In some cases, in the second channel information reporting loop, RI/PMI may be determined as further RI/PMI adaption at the network node according to the second channel information. In other words, in the second channel information reporting loop, the network node may update (or refine) RI/PMI according to the second channel information.

For example, regarding RI/PMI tracking, the second channel information associated with the second RS (e.g., DMRS of PDSCH) includes PMI and RI which are determined by the UE. After receiving the second channel information, the network node determines PMI and RI.

For another example, regarding RI/PMI tracking, the second channel information associated with the second RS (e.g., DMRS of PDSCH) includes at least one of: (1) rank information for PDSCH rank adaptation (e.g., a bit map indicating good quality of a number of ports of the second RS); (2) precoder information for adjusting precoder at network node (e.g., an inter-port interference measurement, such as a covariance matrix, of a number of ports of the second RS); and (3) delay domain information for adjusting precoder per-subband. After receiving the second channel information, the network node determines PMI and RI and CQI according to at least one of these parameters. It should be noted that which parameter(s) is (are) used may be configured by a configuration (e.g., higher layer configuration) from the network node.

In some cases, RI/PMI tracking in the first channel information reporting loop may affect RI/PMI tracking in the second channel information reporting loop. More specifically, the first channel information, resulting from RI/PMI tracking in the first channel information reporting loop, may include parameter(s) for configuring RI/PMI tracking in the second channel information reporting loop. For example, the UE indicates parameters in the first channel information to configure RI/PMI tracking in the second channel information reporting loop. For another example, the UE indicates at least one parameter in the first channel information to inform the network node on how to receive subsequent RS (e.g., SRS) associated with RI/PMI tracking in the second channel information reporting loop.

In some cases, regarding RI/PMI tracking, the type of the first RS (e.g., CSI-RS or SRS) associated with the first channel information reporting loop may be different from the type of the second RS (e.g., CSI-RS, DMRS or SRS) associated with the second channel information reporting loop.

In some cases, when the type of the second RS is SRS, the first channel information may further include parameters for trigger a subsequent SRS while the parameters include at least one of: (1) SRS ports; (2) SRS transmitting bandwidth; (3) frequency hopping; and (4) time-domain repetition. In other words, when the type of the second RS is SRS, the first channel information may further inform the network node of what resource(s) the UE is used for the subsequent SRS.

In some cases, RI/PMI tracking in the first channel information reporting loop may be periodically performed or aperiodically performed (e.g., trigger-based), similar to the first channel information reporting loop. In some cases, RI/PMI tracking in the second channel information reporting loop may be periodically performed or aperiodically performed (e.g., trigger-based), similar to the second channel information reporting loop. In some cases, when both RI/PMI tracking in the first channel information reporting loop and RI/PMI tracking in the second channel information reporting loop are periodically performed, a periodicity of RI/PMI tracking of the first channel information reporting loop may be longer than a periodicity of RI/PMI tracking of the second channel information reporting loop.

In some implementations, parameters associated with MCS may be tracked by different schemes in the first channel information reporting loop and the second channel information reporting loop. More specifically, in the first channel information reporting loop, MCS may be determined as baseline MCS derivation at the network node according to the first channel information. In other words, in the first channel information reporting loop, the network node may determine baseline MCS according to the first channel information. In some cases, when the first channel information includes CQI deriving based on the same RS (i.e., the first RS) for deriving PMI and RI, MCS may be determined with RI/PMI at the network node according to the first channel information. In other words, in the first channel information reporting loop, the network node may determine MCS according to CQI of the first channel information. In some cases, when the first channel information does not include CQI directly, the network may transmit the third RS to the UE for the UE to determine and report the interference measurement information (e.g., interference covariance matrix). After receiving the interference measurement information, the network node may determine CQI and corresponding MCS according to the interference measurement information.

In the second channel information reporting loop, MCS may be further determined as MCS adaption at the network node. In other words, in the second channel information reporting loop, the network node may update (or refine) MCS according to the second channel information. In some cases, when the second channel information includes CQI deriving based on the same RS (i.e., the second RS) for deriving PMI and RI, MCS may be determined with RI/PMI at the network node according to the second channel information. In other words, in the second channel information reporting loop, the network node may update MCS according to CQI of the second channel information. In some cases, when the second channel information does not include CQI directly, the network may transmit the third RS to the UE for the UE to determine and report the interference measurement information (e.g., interference covariance matrix). After receiving the interference measurement information, the network node may determine CQI and corresponding MCS according to the interference measurement information.

In some cases, regarding MCS tracking, the type of the first RS (e.g., CSI-RS or SRS) associated with the first channel information reporting loop may be different from the type of the second RS (e.g., CSI-RS, DMRS or SRS) associated with the second channel information reporting loop.

It should be noted that various combinations of the first RS, the second RS, the first channel information and the second channel information may be utilized in both the first channel information reporting loop and the second channel information reporting loop. Following examples are provided for better understanding but are not intended to limit the scope of the present disclosure.

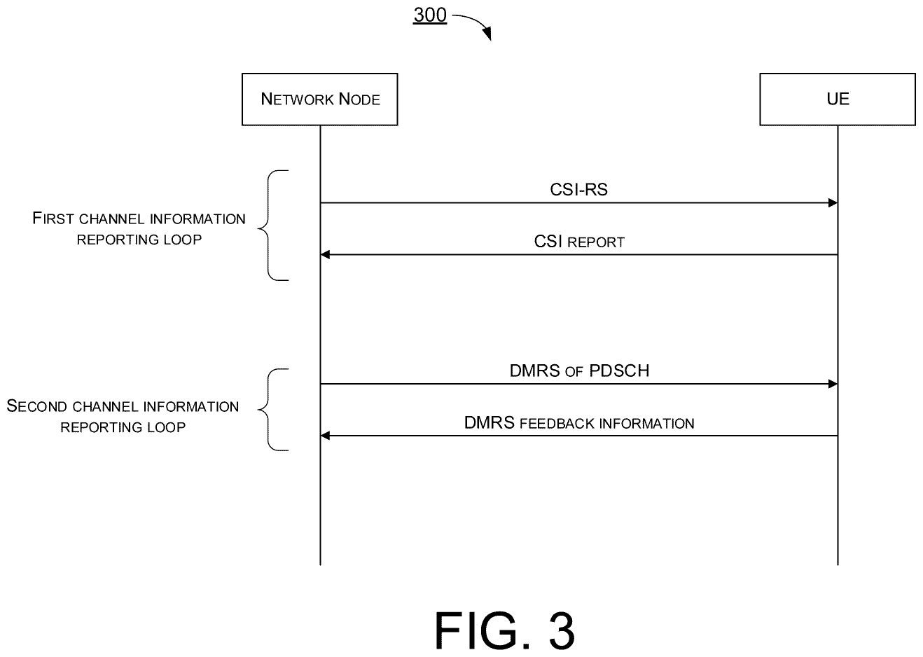

FIG. 3 illustrates an example scenario 300 under schemes in accordance with implementations of the present disclosure. For example, in the first channel information reporting loop, the network node transmits a CSI-RS (i.e., the un-precoded first RS) to the UE. After receiving (i.e., measuring) the CSI-RS, the UE determines RI, PMI and CQI according to the CSI-RS. The UE determines a CSI report (i.e., the first channel information) including RI, PMI and CQI and transmits the CSI report to the network node. After receiving the CSI report, the network node determines RI, PMI and CQI directly according to the CSI report.

In the second channel information reporting loop, the network node transmits a PDSCH including a DMRS (i.e., the precoded second RS) to the UE. After receiving (i.e., measuring) the DMRS, the UE determines RI, PMI and CQI according to the DMRS. The UE determines a DMRS feedback information (i.e., the second channel information) associated with RI, PMI and CQI and transmits the DMRS feedback to the network node. After receiving the DMRS feedback, the network node determines RI, PMI and CQI according to the DMRS feedback and updates RI, PMI and CQI.

From parameters tracking perspective, in the first channel information reporting loop, RI, PMI and CQI (used for determining MCS) are determined based on the CSI report associated with the CSI-RS. In the second channel information reporting loop, RI, PMI and CQI (used for determining MCS) are determined based on the DMRS feedback associated with the DMRS.

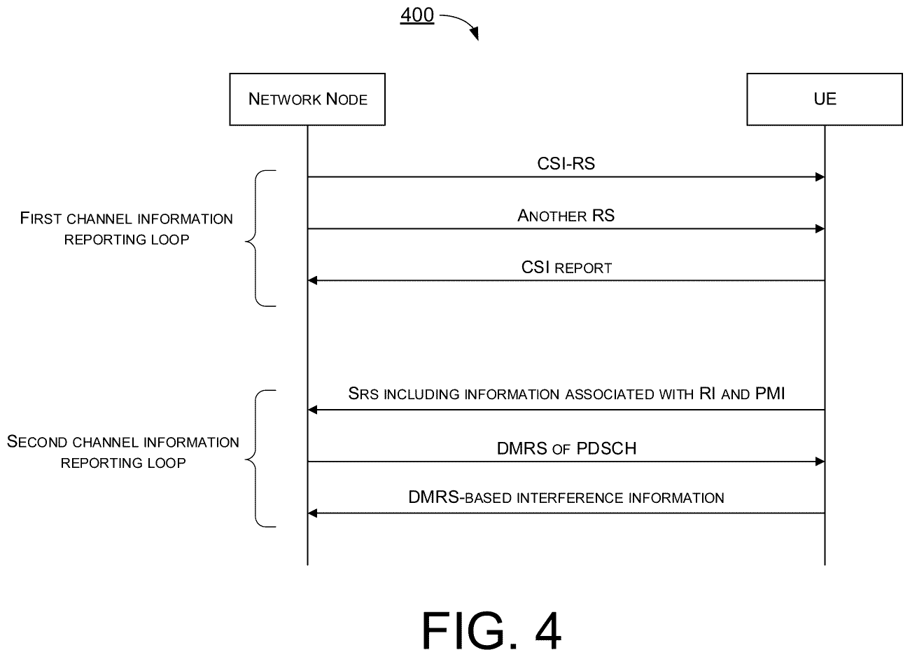

FIG. 4 illustrates an example scenario 400 under schemes in accordance with implementations of the present disclosure. For example, in the first channel information reporting loop, the network node transmits a CSI-RS (i.e., the un-precoded first RS) to the UE. After receiving (i.e., measuring) the CSI-RS, the UE determines first parameters associated with RI and PMI according to the CSI-RS. The first parameters include: (1) reported multipaths; (2) a spatial domain parameter (e.g., AoD at the network node) of the reported multipaths; (3) a delay domain parameter of the reported multipaths; (4) a doppler domain parameter of the reported multipaths; and/or (5) a path gain (e.g., complex gain or power gain) of reported multipaths. In addition, the network node transmits another RS to the UE. After receiving (i.e., measuring) the another RS, the UE determines a second parameter which is an interference covariance matrix.

The UE determines a CSI report (i.e., the first channel information) including the first parameters and the second parameters. The UE then transmits the CSI report to the network node. After receiving the CSI report, the network node determines RI and PMI according to first parameters of the CSI report and determines CQI according to the second parameters of the CSI report. In this example, the UE adds at least one SRS parameter to the CSI report for the network node to receive subsequent SRS. Therefore, after receiving the CSI report, the network node determines how to receive a subsequent SRS from the UE according to the at least one SRS parameter.

In the second channel information reporting loop, the UE transmits an SRS (i.e., the precoded second RS) with information (i.e., the second channel information) associated with RI and PMI to the network node. After receiving the SRS based on the at least one SRS parameter in the CSI report, the network node determines RI and PMI according to the SRS with the information and updates RI and PMI. Further, the network node transmits a PDSCH including a DMRS (i.e., the third RS) to the UE. After receiving the DMRS, the UE determines interference measurement information according to the DMRS and transmits the interference measurement information to the network node. After receiving the interference measurement information, the network node determines CQI according to the DMRS and updates CQI.

From parameters tracking perspective, in the first channel information reporting loop, RI, PMI and CQI (used for determining MCS) are determined based on the CSI report associated with the CSI-RS. In the second channel information reporting loop, RI and PMI are determined based on the SRS and CQI (used for determining MCS) is determined based on the DMRS-based interference measurement information.

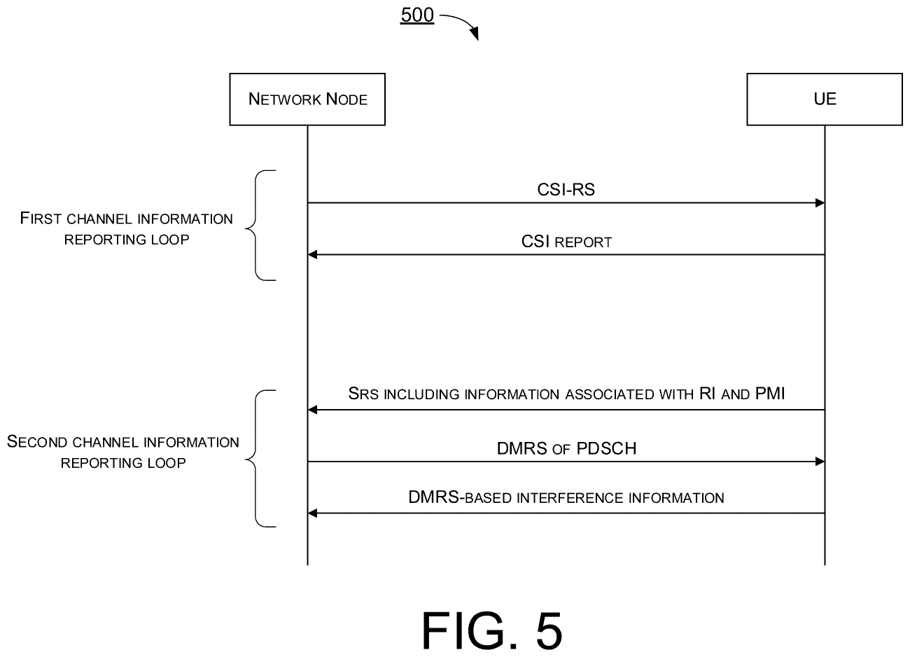

FIG. 5 illustrates an example scenario 500 under schemes in accordance with implementations of the present disclosure. For example, in the first channel information reporting loop, the network node transmits a CSI-RS (i.e., the un-precoded first RS) to the UE. After receiving (i.e., measuring) the CSI-RS, the UE determines first parameters associated with RI and PMI (used for determining beamforming) according to the CSI-RS. The first parameters include: (1) reported multipaths; (2) a spatial domain parameter (e.g., AoD at the network node) of the reported multipaths; and/or (3) a path gain (e.g., complex gain or power gain) of reported multipaths.

The UE determines a CSI report (i.e., the first channel information) including the first parameters. The UE then transmits the CSI report to the network node. After receiving the CSI report, the network node determines RI and PMI according to first parameters of the CSI report. In this example, the spatial domain parameter further indicates subsequent SRS from the UE. Therefore, after receiving the CSI report, the network node determines how to receive a subsequent SRS from the UE according to the spatial domain parameter.

In the second channel information reporting loop, the UE transmits an SRS (i.e., the precoded second RS) with information (i.e., the second channel information) associated with RI and PMI to the network node. After receiving the SRS based on the spatial domain parameter in the CSI report, the network node determines RI and PMI according to the SRS with the information and updates RI and PMI. Further, the network node transmits a PDSCH including a DMRS (i.e., the third RS) to the UE. After receiving the DMRS, the UE determines an interference measurement information according to the DMRS and transmits the interference measurement information to the network node. After receiving the interference measurement information, the network node determines CQI according to the DMRS.

From parameters tracking perspective, in the first channel information reporting loop, RI and PMI are determined based on the CSI report associated with the CSI-RS. In the second channel information reporting loop, RI and PMI are determined based on the SRS and CQI (used for determining MCS) is determined based on the DMRS-based interference measurement information.

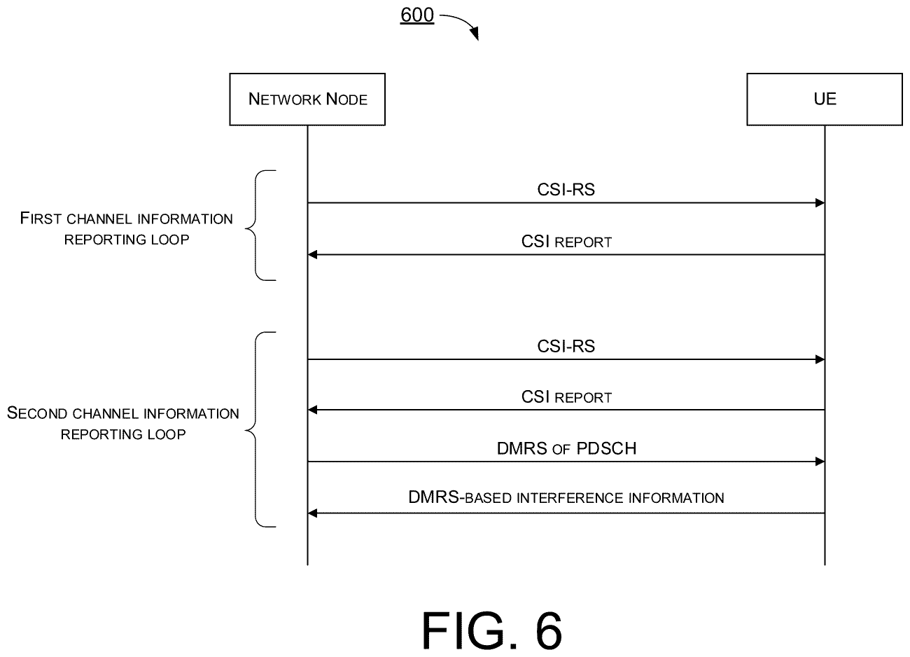

FIG. 6 illustrates an example scenario 600 under schemes in accordance with implementations of the present disclosure. For example, in the first channel information reporting loop, the network node transmits a CSI-RS (i.e., the un-precoded first RS) to the UE. After receiving (i.e., measuring) the CSI-RS, the UE determines parameters associated with RI, PMI and CQI according to the CSI-RS. The parameters include: (1) reported multipaths; (2) a spatial domain parameter (e.g., AoD at the network node) of the reported multipaths; (3) a delay domain parameter of the reported multipaths; (4) a doppler domain parameter of the reported multipaths; (5) a path gain (e.g., complex gain or power gain) of reported multipaths; and/or (6) interference measurement information (e.g., interference covariance matrix). The UE determines a CSI report (i.e., the first channel information) including the parameters. The UE then transmits the CSI report to the network node. After receiving the CSI report, the network node determines RI, PMI and CQI according to parameters of the CSI report.

In the second channel information reporting loop, the network node transmits a CSI-RS (i.e., one of the precoded second RS) to the UE. After receiving (i.e., measuring) the CSI-RS, the UE determines parameters associated with RI and PMI according to the CSI-RS. The parameters include: (1) reported multipaths; (2) a spatial domain parameter (e.g., AoD at the network node) of the reported multipaths; (3) a delay domain parameter of the reported multipaths; (4) a doppler domain parameter of the reported multipaths; and/or (5) a path gain (e.g., complex gain or power gain) of reported multipaths. The UE determines a CSI report (i.e., one of the second channel information) including the parameters. The UE then transmits the CSI report to the network node. After receiving the CSI report, the network node determines RI and PMI according to parameters of the CSI report and updates RI and PMI.

Further, the network node transmits a PDSCH including a DMRS (i.e., another of the precoded second RS) to the UE. After receiving the DMRS, the UE determines interference measurement information according to the DMRS and transmits the interference measurement information to the network node. After receiving the interference measurement information, the network node determines CQI according to the DMRS and updates CQI.

From parameters tracking perspective, in the first channel information reporting loop, RI, PMI and CQI (used for determining MCS) are determined based on the CSI report associated with the CSI-RS. In the second channel information reporting loop, RI and PMI are determined based on another CSI report associated with another CSI-RS, and CQI (used for determining MCS) is determined based on the DMRS-based interference measurement information.

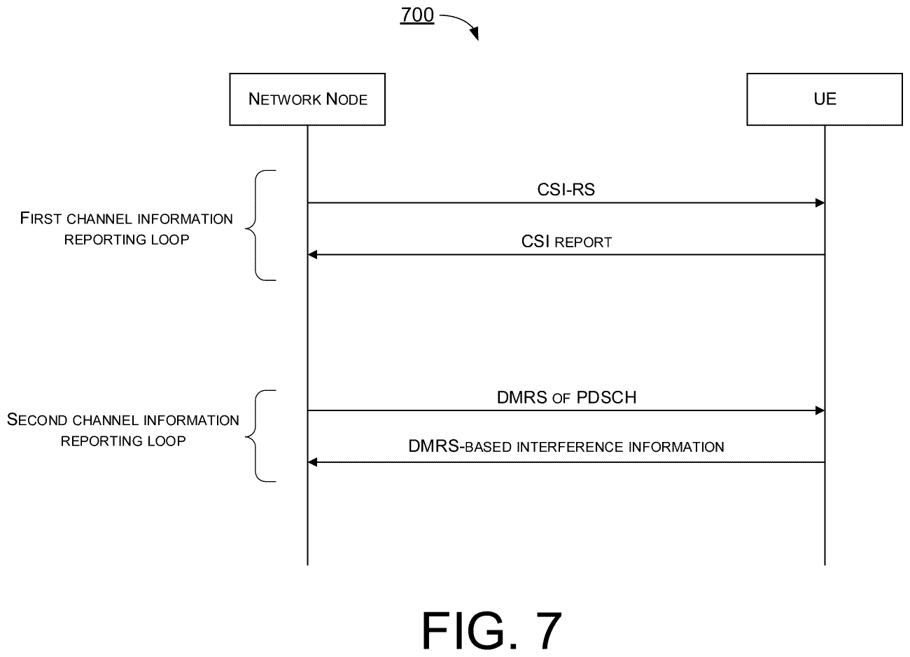

FIG. 7 illustrates an example scenario 700 under schemes in accordance with implementations of the present disclosure. For example, in the first channel information reporting loop, the network node transmits a CSI-RS (i.e., the un-precoded first RS) to the UE. After receiving (i.e., measuring) the CSI-RS, the UE determines parameters associated with RI, PMI and CQI according to the CSI-RS. The parameters include: (1) reported multipaths; (2) a spatial domain parameter (e.g., AoD at the network node) of the reported multipaths; (3) a delay domain parameter of the reported multipaths; (4) a doppler domain parameter of the reported multipaths; (5) a path gain (e.g., complex gain or power gain) of reported multipaths; and/or (6) interference measurement information (e.g., interference covariance matrix). The UE determines a CSI report (i.e., the first channel information) including the parameters. The UE then transmits the CSI report to the network node. After receiving the CSI report, the network node determines RI, PMI and CQI according to parameters of the CSI report.

In the second channel information reporting loop, the network node transmits a PDSCH including a DMRS (i.e., the precoded second RS) to the UE. After receiving the DMRS, the UE determines interference measurement information according to the DMRS and transmits the interference measurement information to the network node. After receiving the interference measurement information, the network node determines CQI according to the DMRS and updates CQI.

From parameters tracking perspective, in the first channel information reporting loop, RI, PMI and CQI (used for determining MCS) are determined based on the CSI report associated with the CSI-RS. In the second channel information reporting loop, only CQI (used for determining MCS) is determined based on the DMRS-based interference measurement information.

### Illustrative Implementations

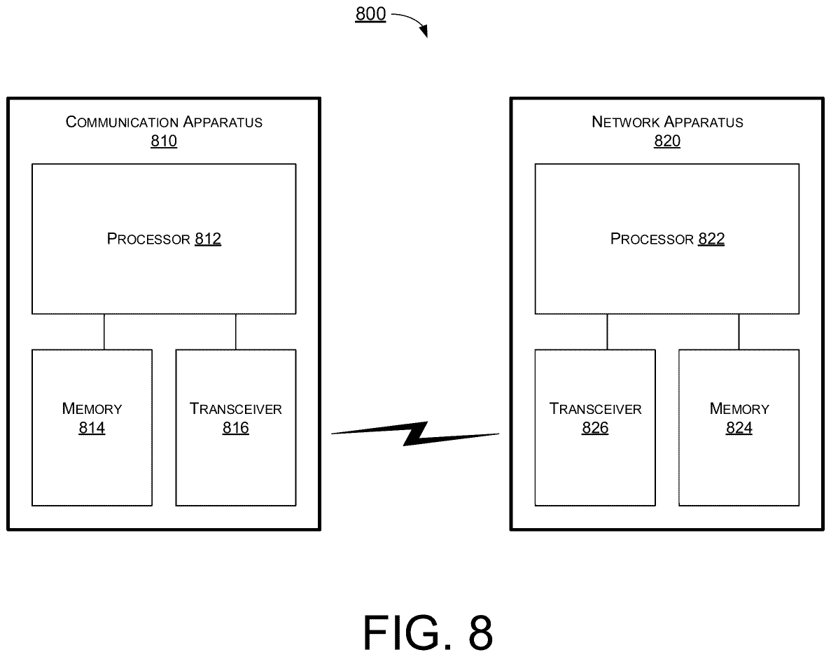

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to reporting channel information with respect to UE and network apparatus in mobile communications, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, a digital camera, or a computing equipment such as a tablet computer, a laptop computer or a notebook computer. Communication apparatus 810 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of a network apparatus, which may be a network node such as a satellite, a base station, a small cell, a router or a gateway. For instance, network apparatus 820 may be implemented in an eNodeB in an LTE network, in a gNB in a 5G/NR, IoT, NB-IoT or IIoT network or in a satellite or base station in a 6G network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including reporting channel information in a device (e.g., as represented by communication apparatus 810) and a network (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In other words, processor 812 may transceive the data such as configuration, message, signal, information, indicator, etc. via transceiver 816. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In other words, processor 822 may transceive the data such as configuration, message, signal, information, indicator, etc. via transceiver 826. In some implementations, network apparatus 820 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively. To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

In some implementations, each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

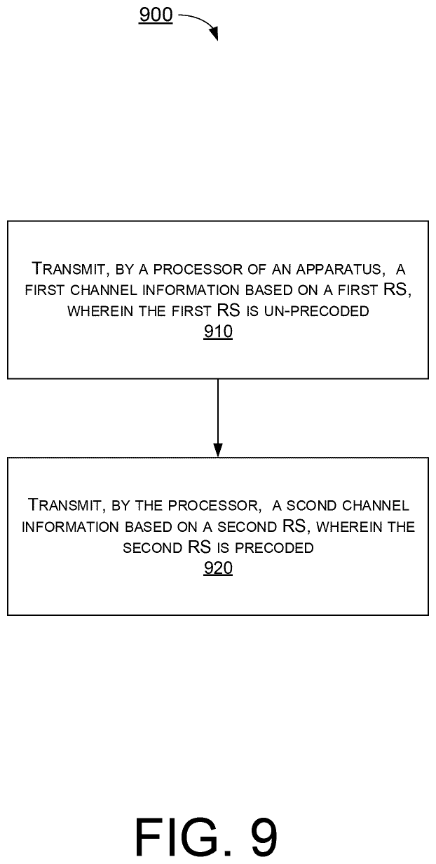

FIG. 9 illustrates an example process 900 in accordance with an implementation of the present disclosure. Process 900 may be an example implementation of above scenarios/schemes, whether partially or completely, with respect to reporting channel information of the present disclosure. Process 900 may represent an aspect of implementation of features of communication apparatus 910. Process 900 may include one or more operations, actions, or functions as illustrated by one or more of blocks 910 to 920. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 910 or any suitable UE or machine type devices. Solely for illustrative purposes and without limitation, process 900 is described below in the context of communication apparatus 910. Process 900 may begin at block 910.

At block 910, process 900 may involve processor 812 of communication apparatus 810 transmitting a first channel information based on a first RS. The first RS may be un-precoded. Process 900 may proceed from block 910 to block 920.

At block 920, process 800 may involve processor 812 of communication apparatus 810 transmitting a second channel information based on a second SR. The second RS may be precoded.

In some implementations, the transmission of the second channel information may be based on an aperiodic signaling.

In some implementations, the first channel information may include at least one parameter associated with the second RS.

In some implementations, process 900 may involve processor 812 receiving the first RS from a network node. The first RS may include a CSI-RS. The first channel information may be associated with at least one of precoded, rank and channel quality.

In some implementations, the first channel information includes at least one of: (1) reported multipaths; (2) a spatial domain parameter of the reported multipaths; (3) a delay domain parameter of the reported multipaths; (4) a doppler domain parameter of the reported multipaths; (5) a path gain of reported multipaths; and (6) interference measurement information.

In some implementations, process 900 may involve processor 812 transmitting the first RS associated with the first channel information to a network node. The first RS may include an SRS. The first channel information may be associated with at least one of precoder and rank.

In some implementations, process 900 may involve processor 812 transmitting the second RS associated with the second channel information to a network node. The second RS may include an SRS. The second channel information may be associated with at least one of precoder and rank.

In some implementations, process 900 may involve processor 812 transmitting a third channel information based on a third RS transmitted from the network node. The third channel information may be associated with channel quality.

In some implementations, process 900 may involve processor 812 receiving the second RS from a network node. The second RS may include a CSI-RS or a DMRS of a PDSCH. The second channel information may be associated with at least one of precoder, rank and channel quality.

In some implementations, process 900 may involve processor 812 determining interference measurement information based on a third RS transmitted from the network node. Process 900 may involve processor 812 transmitting the interference measurement information to the network node.

In some implementations, the second RS may be a DMRS, and the second channel information may include at least one of: (1) information related to deriving MCS for PDSCH transmission; (2) information for PDSCH rank adaptation; (3) information for adjusting precoder at the network node; and (4) delay domain information for adjusting precoder per-subband.

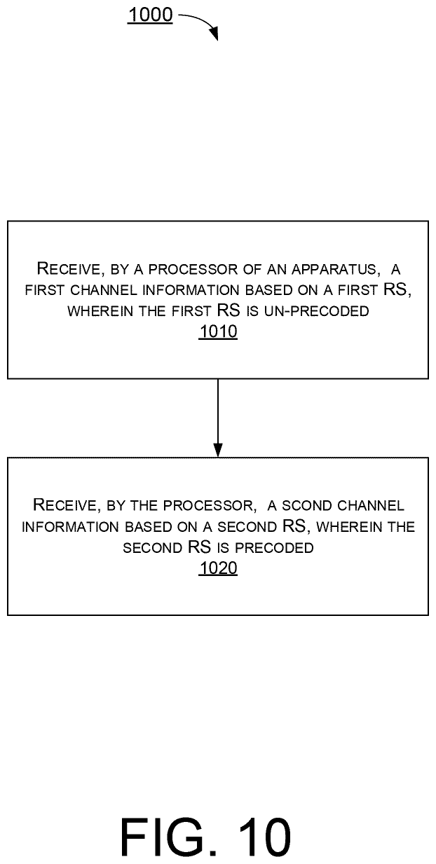

FIG. 10 illustrates an example process 1000 in accordance with an implementation of the present disclosure. Process 1000 may be an example implementation of above scenarios/schemes, whether partially or completely, with respect to reporting channel information of the present disclosure. Process 1000 may represent an aspect of implementation of features of network apparatus 820. Process 1000 may include one or more operations, actions, or functions as illustrated by one or more of blocks 1010 to 1020. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 820 or any suitable network device or machine type devices. Solely for illustrative purposes and without limitation, process 1000 is described below in the context of network apparatus 820. Process 1000 may begin at block 1010.

At block 1010, process 1000 may involve processor 822 of network apparatus 820 receiving a first channel information bases on a first RS. The first RS may be un-precoded. Process 10 may proceed from block 1010 to block 1020.

At block 1020, process 1000 may involve processor 822 of network apparatus 820 receiving a second channel information based on a second RS. The second RS may be precoded.

In some implementations, the first channel information may include at least one parameter associated with the second RS.

In some implementations, process 1000 may involve processor 822 transmitting the first RS to a UE. The first RS may include CSI-RS. Process 1000 may involve processor 822 determining at least one of precoder, rank and channel quality according to the first channel information.

In some implementations, process 1000 may involve processor 822 receiving the first RS associated with the first channel information from a UE. The first RS may include an SRS. Process 1000 may involve processor 822 determining at least one of precoder and rank according to the first channel information.

In some implementations, process 1000 may involve processor 822 receiving the second RS associated with the second channel information from a UE. The second RS may include an SRS. Process 1000 may involve processor 822 determining at least one of precoder and rank according to the second channel information.

In some implementations, process 1000 may involve processor 822 receiving a third channel information based on a third RS transmitted from the UE. Process 1000 may involve processor 822 determining channel quality according to the third channel information.

In some implementations, process 1000 may involve processor 822 transmitting the second RS to a UE. The second RS may include a CSI-RS or a DMRS of a PDSCH. Process 1000 may involve processor 822 determining at least one of precoder, rank and channel quality according to the second channel information.

In some implementations, process 1000 may involve processor 822 transmitting a third RS to the UE for determining interference measurement information based on the third RS. Process 1000 may involve processor 822 receiving the interference measurement information from the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of apparatus, a first channel information based on a first reference signal (RS), wherein the first RS is un-precoded; and
transmitting, by the processor, a second channel information based on a second RS, wherein the second RS is precoded.

2. The method of claim 1, wherein the transmission of the second channel information is based on an aperiodic signaling.

3. The method of claim 1, wherein the first channel information includes at least one parameter associated with the second RS.

4. The method of claim 1, further comprising:
receiving, by the processor, the first RS from a network node, wherein the first RS includes a channel state information RS (CSI-RS);
wherein the first channel information is associated with at least one of a precoder, a rank and a channel quality.

5. The method of claim 1, wherein the first channel information includes at least one of:
reported number of multipaths;
a spatial domain parameter of the reported multipaths;
a delay domain parameter of the reported multipaths;
a doppler domain parameter of the reported multipaths;
a path gain of reported multipaths; and
an interference measurement information.

6. The method of claim 1, wherein the step of transmitting the first channel information bases on the first RS further comprises:
transmitting, by the processor, the first RS associated with the first channel information to a network node, wherein the first RS includes a sounding reference signal (SRS);
wherein the first channel information is associated with at least one of a precoder and a rank.

7. The method of claim 1, wherein the step of transmitting the second channel information bases on the second RS further comprises:
transmitting, by the processor, the second RS associated with the second channel information to a network node, wherein the second RS includes a sounding reference signal (SRS);
wherein the second channel information is associated with at least one of a precoder and a rank.

8. The method of claim 1, further comprising:
transmitting, by the processor, a third channel information based on a third RS transmitted from the network node, wherein the third channel information is associated with a channel quality.

9. The method of claim 1, further comprising:
receiving, by the processor, the second RS from a network node, wherein the second RS includes a channel state information RS (CSI-RS) or a demodulation reference signal (DMRS) of a physical downlink shared channel (PDSCH);
wherein the second channel information is associated with at least one of a precoder, a rank and a channel quality.

10. The method of claim 9, further comprising:
determining, by the processor, interference measurement information based on a third RS transmitted from the network node; and
transmitting, by the processor, the interference measurement information to the network node.

11. The method of claim 1, wherein the second RS is a demodulation reference signal (DMRS) of a physical downlink shared channel (PDSCH), and the second channel information includes at least one of:
information related to deriving modulation and coding scheme (MCS) for PDSCH transmission;
information for PDSCH rank adaptation;
information for adjusting precoder at the network node; and
delay domain information for adjusting precoder per-subband.

12. A method, comprising:
receiving, by a processor of apparatus, a first channel information bases on a first reference signal (RS), wherein the first RS is un-precoded; and
receiving, by the processor, a second channel information based on a second RS, wherein the second RS is precoded.

13. The method of claim 12, wherein the first channel information includes at least one parameter associated with the second RS.

14. The method of claim 12, further comprising:
transmitting, by the processor, the first RS to a user equipment (UE), wherein the first RS includes a channel state information RS (CSI-RS); and
determining, by the processor, at least one of a precoder, a rank and a channel quality according to the first channel information.

15. The method of claim 12, wherein the step of receiving the first channel information bases on the first RS further comprises:
receiving, by the processor, the first RS associated with the first channel information from a user equipment (UE), wherein the first RS includes a sounding reference signal (SRS); and
determining, by the processor, at least one of a precoder and a rank according to the first channel information.

16. The method of claim 12, wherein the step of receiving the second channel information bases on the second RS further comprises:
receiving, by the processor, the second RS associated with the second channel information from a user equipment (UE), wherein the second RS includes a sounding reference signal (SRS); and
determining, by the processor, at least one of a precoder and a rank according to the second channel information.

17. The method of claim 12, further comprising:
receiving, by the processor, a third channel information based on a third RS transmitted from the UE; and
determining, by the processor, a channel quality according to the third channel information.

18. The method of claim 12, further comprising:
transmitting, by the processor, the second RS to a user equipment (UE), wherein the second RS includes a channel state information RS (CSI-RS) or a demodulation reference signal (DMRS) of a physical downlink shared channel (PDSCH); and
determining, by the processor, at least one of a precoder, a rank and a channel quality according to the second channel information.

19. The method of claim 18, further comprising:
transmitting, by the processor, a third RS to the UE for determining interference measurement information based on the third RS; and
receiving, by the processor, the interference measurement information.

20. An apparatus, comprising:
a transceiver which, during operation, wirelessly communicates with a wireless network; and
a processor communicatively coupled to the transceiver such that, during operation, the processor performs operations comprising:
transmitting, via the transceiver, a first channel information bases on a first reference signal (RS), wherein the first RS is un-precoded; and
transmitting, via the transceiver, a second channel information based on a second RS, wherein the second RS is precoded.
